(19) United States
(12) Patent Application Publication
(10) Pub. No.: US 2025/0038231 A1
(43) Pub. Date: Jan. 30, 2025

(54) HUMIDIFIER STACK, HUMIDIFIER DEVICE, AND MEMBRANE FOR HUMIDIFIER STACK

(71) Applicant: MANN+HUMMEL GmbH, Ludwigsburg (DE)

(72) Inventors: Herbert JAINEK, Heilbronn (DE); Matthias TESCHNER, Ludwigsburg (DE); Benedikt WELLER, Steinheim (DE)

(21) Appl. No.: 18/916,713

(22) Filed: Oct. 16, 2024

Related U.S. Application Data
(63) Continuation of application No. PCT/EP2023/062423, filed on May 10, 2023.

(30) Foreign Application Priority Data
May 13, 2022 (DE) 102022112009.0

(51) Int. Cl. H01M 8/04119

(52) U.S. Cl. CPC H01M 8/04149; H01M 8/04141

(57) ABSTRACT

A humidifier stack for a humidifier device includes frame plates following each other in a stacking direction in a plate stack including a dry gas channel and a moist gas channel, and a membrane separating the dry gas channel and the moist gas channel, the membrane enabling a moisture transfer from a fluid flow being guided in the moist gas channel to a fluid flow being guided in the dry gas channel. The humidifier stack further includes an at least partially circumferentially extending seal fixedly connected to the membrane, the at least partially circumferentially extending seal including flow channel seal sections disposed along circumferential edges of a moisture transfer surface of the membrane at a first surface of the membrane.

### CROSS-REFERENCE TO RELATED APPLICATION

This application is a continuation application of International Application No. PCT/EP2023/062423 filed on May 10, 2023, which claims the benefit of German Application No. 102022112009.0 filed on May 13, 2022, the entire disclosures of which are incorporated herein by reference for all purposes.

### BACKGROUND

Embodiments concern a humidifier stack, in particular for a fuel cell system, a humidifier device, and furthermore a membrane for the humidifier stack.

Humidifier devices for fuel cell systems are known from the prior art in various embodiments, wherein a differentiation is made between the two principal technologies of the hollow fiber humidifiers, on the one hand, and the flat membrane humidifiers, on the other hand.

A humidifier device is an indispensable component of a fuel cell system because it ensures that an electrolyte membrane used in the fuel cell stack is always present in the moistened state so that the electrolytes therein exist in a hydrated state. When the electrolyte membrane of the fuel cell system is not moist enough, the conductivity of the electrolyte decreases which reduces the performance of the fuel cell. In order to operate a fuel cell stack with optimal performance and/or optimal degree of efficiency, a humidifier device is therefore a core component.

All known humidifier devices have in common that they humidify a dry cathode air flow supplied to the fuel cell stack in that moisture from a moist exhaust air flow coming from the fuel cell is supplied to this dry air flow. In general, the dry air flow supplied to the fuel cell stack and the moist air flow coming from the fuel cell stack are guided in crossflow or counterflow across a moisture-permeable membrane at which the moisture transfer takes place.

Known flat membrane humidifiers comprise a plurality of stacked frame plates which form a plurality of dry gas and moist gas channels separated by a moisture-permeable membrane from each other, respectively.

In this context, the membrane is in general fixedly connected to the respective frame plates, for example, glued or welded.

Such humidifier devices are, for example, known from DE 10 2016 014 895 A1 and DE 10 2019 123 534 A1.

Since a high thermal load (in the form of the thermal energy contained in the exhaust gas flow) as well as mechanical loads (in the form of a pressure gradient attacking via the membrane surface) occur in operation of the humidifier device in a fuel cell system, the connection of the membrane to the frame plates is a potential point of weakness that can lead to a premature failure of the humidifier device. The aforementioned problem is further exacerbated by pressure peaks occurring under certain conditions during operation.

Moreover, in known humidifier devices which rely on a direct connection of the membrane to the frame plates, there is the disadvantage that this connection in the manufacturing process is complex and prone to failure and requires continuous quality controls.

Finally, a tolerance problem may result in known concepts: Since a typical humidifier stack is comprised of up to 300 stack layers, the tolerances in the stacking direction add up; this, in sum, can lead to dimensional deviations in the millimeter range which are correspondingly difficult to compensate by compensation elements.

### SUMMARY

An object of the embodiments is therefore to provide a humidifier stack for a humidifier device, in particular for a fuel cell system, which comprises an improved thermal and mechanical robustness and therefore enables a disturbance-free operation across extended periods of time and which furthermore can be produced easier and less expensively than known humidifier stacks.

This object is solved by a humidifier stack with the features of the independent claim 1.

A further object is providing a humidifier device, in particular for a fuel cell system.

This object is solved by a humidifier device with the features of the claims 26 and 27.

A still further object is providing a membrane for the humidifier stack.

Beneficial embodiments and advantages of the embodiments result from the additional claims, the description, and the drawings.

The humidifier stack according to the embodiments for a humidifier device, in particular for a fuel cell system, comprises a plurality of frame plates which are following each other in a stacking direction in a plate stack. In the plate stack, at least two groups of flow channels are formed which are separated by a membrane, respectively. A first group of channels comprises moist gas channels and a second group of channels comprises dry gas channels. The membrane permits a moisture transfer from a fluid flow guided in the moist gas channel to a fluid flow guided in the dry gas channel. According to the embodiments, the membrane is provided with an at least partially circumferentially extending seal which, at least in sections, is in sealing contact at neighboring frame plates. The circumferentially extending seal comprises at least two flow channel seal sections which are present at two or more circumferential edges of a moisture transfer surface provided by the membrane at a first surface of the membrane, wherein at least two other circumferential edges of the moisture transfer surface provided by the membrane at the first surface are free of flow channel seal sections. The flow channel seal sections seal now relative to a neighboring frame plate in order to form one of the flow channels in a region which is delimited by the membrane, by the neighboring frame plate, by a neighboring further membrane, and by the flow channel seal sections.

The membrane can comprise in particular a film of PTFE or PFSA. The film is preferably framed or laminated sandwich-like between two nonwoven layers, in particular of PET, PPS, or PA. The advantage of this lamination resides in that the film, which is very thin and therefore difficult to handle and mechanically not very robust, is protected. Moreover, the nonwoven at the surface facilitates the attachment of the at least partially circumferentially extending seal at the membrane because the film has a very slick surface and therefore is not well suited as point of attack for joining methods. The nonwoven, on the other hand, comprises a porous or rough structure and is therefore significantly better suited for joining.

The flow channels which are formed by the plate stack can have dimensions of 0.5 mm-3 mm in the stacking direction (height). The dry gas channels can have in this context a larger height than the moist gas channels. This is advantageous because in this way a reduced pressure loss is generated in the dry gas channels; in the system context, this is beneficial for the efficiency of the fuel cell stack because in this way the cathode side of the fuel cell stack can be provided with a pressure level as high as possible.

Advantageously, the humidifier stack according to the embodiments is less failure-prone in regard to the thermal and mechanical loads occurring in operation in comparison to known humidifier stacks. This is achieved primarily in that, according to the embodiments, the flow channel seal sections of the at least partially circumferentially extending seal are present at the membrane and the membrane is embodied separate from the frame plates. The sealing action of the membranes and frame plates for forming the flow channels is realized advantageously exclusively by compression of the plate stack, i.e., by friction force. The pretension force required for this can be determined without problem taking into consideration the settling and creeping behavior of the material of the at least partially circumferentially extending seal.

However, the humidifier stack according to the embodiments is not only advantageous in operation. It is also superior to known humidifier stacks in regard to manufacture. This is also achieved again in particular due to the configuration of the flow channel seal sections of the at least partially circumferentially extending seal. The circumferentially extending seal can be fastened at the membrane by established molding or primary forming methods in a trouble-free, reliable, and quick manner. Since the seal tightness in the mounted state is achieved purely by friction force due to compression of the plate stack, no increased demands are imposed on the connection quality between at least partially circumferentially extending seal and membrane; especially, no similarly complex quality control is required as in humidifier stacks of the prior art relying on a direct connection of the membrane to the frame plates.

In embodiments, the plate stack can be held together by at least one clamping force generating device, in particular one or a plurality of tie rods, wherein the membranes in the plate stack are fastened exclusively by clamping action. A stack construction in which the membranes are not glued to the frame plates is advantageous with respect to a significantly more reliable manufacture (no failure-prone gluing step). Moreover, advantages exist with respect to an improved durability (adhesive connection problematic in particular under the effect of heat, moisture, and vibration) and there exists a significant cost savings potential due to the manufacturing processes which can be automated better. As an alternative to a tie rod as clamping force generating device, also a tensioning strap or another device component appearing suitable to a person of skill in the art can be used in order to load the humidifier stack in the stacking direction by a clamping force.

In a further embodiment, the moisture transfer surface provided by the membrane can have a polygonal, in particular rectangular, shape. The flow channel seal sections are positioned in this context at two or more oppositely positioned circumferential edges of the moisture transfer surface at the first surface of the membrane, wherein at least two other oppositely positioned circumferential edges of the moisture transfer surface at the first surface of the membrane are free of flow channel seal sections. In case of a rectangular shape, a square shape can also be provided in a special embodiment; this increases the potential for use of same parts, for the frame plates as well as for the membranes, and thereby provides a significant cost savings potential.

In the regions of the two other circumferential edges of the moisture transfer surface provided by the membrane which are free of flow channel seal sections at the first surface, inflow and outflow cross sections into the flow channels of one of the two groups of flow channels are provided, respectively.

In analogy, the membrane can be free of flow channel seal sections at a second surface, which is facing away from the first surface, along the at least two circumferential edges at which at the first surface flow channel seal sections are present. In this way, corresponding inflow and outflow cross sections are provided into the other group of flow channels.

In a preferred embodiment, the circumferentially extending seal can be connected fixedly to the membrane, in particular can be injection-molded or glued to the membrane. In particular, the circumferentially extending seal can comprise or be comprised of a silicone. Moreover, in embodiments the seal can comprise or be comprised of EPDM or thermoplastic elastomers. The adhesive connection of the circumferentially extending seal to the membrane can be in particular realized by an adhesive strip. However, an adhesive connection with a curable liquid adhesive is conceivable also. In principle, it is sufficient for the concept according to the embodiments when the circumferentially extending seal is only fixed at the membrane in order to enable the assembly of the humidifier stack because the sealing action is primarily provided by friction force via the compression of the humidifier stack.

Moreover, at least one of the flow channel seal sections can comprise at least one seal lip, preferably two or more seal lips. Due to the use of seal lips, an optimized relation between compression force and seal deformation is achieved so that the compression force, which is required for achieving a predetermined seal action, is reduced due to this measure. This aspect is in particular very important for stacking a plurality of frame plate-membrane units because the compression forces add up like a serial connection.

In embodiments, a thickness of the flow channel seal sections can be many times larger than a thickness of the membrane, wherein the thickness of the flow channel seal sections is at least 3 times, preferably at least 5 times, in particular at least 7 times, as large as a thickness of the membrane. The channel dimensions are also substantially defined by the height of the flow channel seal sections. The total height of a flow channel results from the (compressed) height of the flow channel seal and the thickness of the frame plate relative to which the flow channel seal seals.

Moreover, at least one of the flow channel seal sections can be guided around at least one circumferential edge of the moisture transfer surface provided by the membrane, in particular injection-molded around, and engage around the circumferential edge in particular in a U-shape. This is advantageous because in this way the mechanical anchoring of the flow channel seal in/at the membrane material is improved. Moreover, the membrane is protected in this way at the rear side from mechanical load or abrasion; this is further contributing to a failsafe operation. In embodiments, the membrane can be perforated in regions to which the flow channel seal is injection-molded so that seal material can penetrate the membrane; this further improves the attachment or anchoring of the seal to the membrane.

In yet another embodiment, a main flow direction in the moist gas channels can extend at an angle to a main flow direction in the dry gas channels, wherein, for membranes immediately following each other in the plate stack, the at least two flow channel seal sections are present respectively at circumferential edges that are different from each other. In this way, the humidifier stack according to the embodiments can be operated preferably in crossflow which, on the one hand, is advantageous for a moisture transfer as efficient as possible because the dry and moist volume flows can be distributed particularly homogeneously across the moisture transfer surface of the membrane in this way. On the other hand, in an embodiment of the humidifier device with a separate housing, the sealing action of the humidifier stack in relation to corresponding supply and discharge connectors for the dry and moist fluid flows is simplified.

In embodiments, in particular in embodiments in which the basic shape of the membrane is of rotational symmetry, i.e., for example, in case of a square basic shape, the membrane can be identical in all stack layers of the plate stack and the installation direction of the membrane in neighboring stack layers of the plate stack can be respectively rotated, in particular rotated by 90°, respectively.

As an alternative or in addition, the installation direction of the frame plates in neighboring stack layers of the plate stack can be respectively rotated, in particular rotated by 90°, respectively, wherein preferably the frame plates in all stack layers of the plate stack are identical.

The frame plates can comprise or be comprised of a metallic sheet metal material, in particular sheet steel. Frame plates of a sheet metal material, in particular in the form of a sheet steel of stainless steel, provide the advantage of an excellent thermal and chemical resistance and, moreover, can be produced with established and inexpensively realizable manufacturing methods (punching, bending). The thickness of the employed sheet metal in particular can amount to 0.2 mm-0.8 mm, preferably 0.3 mm-0.5 mm.

In embodiments, at least one membrane support element and/or at least one flow mixing element, in particular a flow grid, can be present between at least two neighboring membranes. The membrane support element and/or the flow mixing element extends advantageously across the complete moisture transfer surface of the membrane and supports it in relation to pressure gradients acting on the moisture transfer surface. The membrane support element and/or the flow mixing element can be embodied in particular of a one-piece configuration so that both functions are combined in one device component. The flow mixing element acts as a flow distributor and can induce turbulences in a targeted fashion; this has the result that the available moisture transfer surface can be utilized as efficiently as possible for moisture exchange. The flow mixing element can therefore be in particular a laminar mixer. In addition to plastic materials, in particular PPS or PET, also metals, in particular stainless steel, are conceivable as material for the membrane support element and/or flow mixing element, in particular flow grid. The membrane support element and/or flow mixing element can comprise in particular a cross structure which comprises a plurality of webs or ribs which are crossing each other at an angle. In this way, on the one hand, the support surface is maximized and, on the other hand, the flow mixing action is optimized because a two-dimensional influence on the flow is achieved. The membrane support element and/or flow mixing element can be a device component which is inserted separately into the plate stack. However, the membrane support element and/or flow mixing element can also be formed at the frame plates in embodiments, in particular as one piece together with the frame plate. Membrane support elements and/or flow mixing element which are correspondingly integrated into the frame plates can be realized from a flat starting material provided for the frame plates, for example, by simple punching and bending methods.

In a further preferred embodiment, the frame plates can comprise at least one support element projecting away from a plate base plane. Between an end of the support element facing away from the plate base plane and the plate base plane, at least one flow opening is formed which opens into one of the flow channels of the at least two groups of flow channels. In a region of the at least two circumferential edges of the membrane at which flow channel seal sections are present at the first surface, the support element is supported at the second surface of the membrane, which is facing away from the first surface and which is free of flow channel seal sections, in order to introduce a seal pretension into the flow channel seal sections.

The support element can be embodied in particular as a local elevation out of the plate base plane, in particular as a deep-drawn domed portion. In particular, a plurality of spaced-apart support elements can be present distributed along the circumferential edge. This is advantageous in order to transmit the compression forces as homogeneously as possible and without local pressure peaks.

In a preferred special embodiment, the support element can be embodied as a pressure bar extending along the respective circumferential edge, wherein the pressure bar contacts preferably areally the circumferential edge of the membrane. In this way, the homogeneity of the introduction of the compression forces is further optimized and a local damage of the membrane at the second surface is reliably prevented. In regard to manufacture, the pressure bar can be produced of a plate-shaped basic material of the frame plates by separation and forming processes which can be controlled well and are inexpensive, for example, punching and bending.

In an also preferred further embodiment, the pressure bar can be embodied as a folded-over, in particular bent section, of the plate material. In this context, the flow opening is in particular embodied between spaced-apart bent sections of the frame plate which connect the plate base plane to the pressure bar. The bent section can be understood as a web which connects the plate base plane to the pressure bar after producing the flow openings, for example, by punching.

In yet another also preferred embodiment, the bent sections can be designed to be elastically springy and in particular can store a clamping force generated by the clamping force generating device. The elastically springy property of the bent section relates in particular to the stacking direction. The reason for the elastically springy property is an elastic deformation in the bent sections which act essentially as a leaf spring in this way. This elastically springy property is of particular importance in order to maintain the seal compression in the plate stack even in case of the intrinsic sealing pretension decreasing over time due to settling processes in the material of the at least partially circumferentially extending seal. This is therefore an important measure in order to maintain the seal tightness of the plate stack over a period of time which is as long as possible.

In embodiments, the support elements can also be formed at the membrane. In particular, the support elements can be formed by a plurality of neighboring elevations or knobs which are arranged along the circumferential edge of the membrane at which no flow channel seal sections are present at the first surface. The elevations or knobs are positioned, like the flow channel seal sections, at the first surface of the membrane. Between the membrane-side support elements, flow openings are formed which open into one of the flow channels of the at least two groups of flow channels. The membrane-side support elements can be supported at a neighboring frame plate. Advantageously, the membrane-side support elements can be comprised of the same material as the flow channel seal sections and can be produced in a common process step together with the flow channel seal sections, in particular, by injection molding.

In embodiments, at the second surface along the at least two circumferential edges at which flow channel seal sections are present at the first surface, the membrane can comprise a second seal which is in contact with the at least one support element, in particular the pressure bar, of the respective neighboring frame plate.

In particular, the secondary seal can be formed by the section of at least one of the flow channel seal sections which is guided around the circumferential edge and in particular injection-molded. This enables providing the secondary seal in a common working step together with the flow channel seal section(s), which makes the manufacture of the humidifier stack according to the embodiments more cost-efficient. Alternatively, the flow channel seal sections and the secondary seal can also be applied only surficially on the membrane surfaces facing away from each other without engaging around the edge of the membrane.

It can be in particular provided that a thickness of the secondary seal is smaller than the thickness of the flow channel seal sections and/or the secondary seal is embodied as a flat seal. The thickness of the secondary seal in particular can be 2 times or even 3 times smaller than the thickness of the flow channel seal sections.

In a further preferred embodiment, the plate stack can form supply and discharge channels which extend in the stacking direction and are connected in fluid communication to the at least two groups of flow channels. This embodiment of the humidifier stack, together with corresponding end plates, can be used, without a housing which is separate from or external to the humidifier stack, directly as a humidifier device because the supply and discharge of the dry and moist volume flows is enabled by a corresponding configuration within the plate stack.

In particular, a first supply channel as dry gas supply channel can be connected at the inlet side to the dry gas channels and a second supply channel as moist gas supply channel can be connected at the inlet side to the moist gas channels. As an alternative or in addition, a first discharge channel as dry gas discharge channel can be connected at the outlet side to the dry gas channels and a second discharge channel as moist gas discharge channel can be connected at the outlet side to the moist gas channels.

The respective supply and discharge channels are formed in particular by corresponding flow pockets in the frame plates and/or the membranes which form the supply and discharge channels when stacked. The flow pockets can be understood as self-contained recesses in the structure of the frame plates and/or of the membranes which, when stacked on each other in the stacking direction, form the supply and discharge channels extending in the stacking direction. The flow pockets are present in particular in a region which is lying outside of the moisture transfer surface.

In a particular embodiment, the membranes, in a region externally surrounding the flow pockets, are provided respectively with a flow pocket seal which seals in particular bidirectionally in relation to neighboring frame plates, wherein in particular the flow pocket seal is connected fixedly to the membrane, in particular is injection-molded or glued to the membrane. The flow pocket seal can also be provided in particular with one or more seal lips in order to minimize the required compression forces for achieving a predetermined sealing action. A flow pocket seal formed directly at the membrane has the advantage that it can be produced in a common working step together with the flow channel seal sections of the at least partially circumferentially extending seal; this further reduces the manufacturing costs.

In another embodiment, the flow pocket seal can also be embodied as a seal separate from the membranes and can be connected in the region externally surrounding the flow pockets either with one of the frame plates neighboring each other or can be inserted loosely between the frame plates. Even in the latter case of the configuration of the flow pocket seal separate from the membrane, it seals however bidirectionally against the respective neighboring frame plates.

In yet another also preferred embodiment, between two neighboring frame plates at least one compression limitation element can be arranged which presets a minimum distance of the neighboring frame plates and in this way limits a compression of the circumferentially extending seal of the membrane in the stacking direction. The compression limitation element can be formed in particular at one or more of the frame plates and can contact a neighboring frame plate. In other embodiments, the compression limitation element however can be separate from the frame plates and in particular can be inserted as an insert part of a predetermined thickness between two neighboring frame plates. The insert part can be a sheet metal strip of a predetermined thickness, in particular a washer. The compression limitation element provides an effective measure in order to always ensure a predetermined pretension of the at least partially circumferential seal during manufacture, in particular of its flow channel seal sections. Practically, the plate stack, in particular by a clamping force generating device such as a threaded rod, can be compressed so strongly until the compression limitation elements present between two frame plates, respectively, contact each other. With respect to measuring technology, this state can be determined simply by monitoring the tightening torques. Alternatively, the plate stack can also be pretensioned by a controlled pressure force generating device, for example, a compression or tension test machine, and subsequently the threaded rods can be provided with nuts in order to maintain the adjusted pretension. A further positive effect of the compression limitation element is provided in that an effective tolerance management for the entire stack construction is possible in this way. When using compression limitation elements, the length tolerance in the stacking direction depends no longer on a possibly varying seal compression but exclusively on the dimensional tolerances of the frame plates which can be significantly better controlled with respect to process technology, in particular their thickness and dimensions of the compression limitation elements in the stacking direction. This is therefore an important measure in order to enable a mass production of the humidifier stack according to the embodiments.

A further aspect of the embodiments concerns a humidifier device, in particular for a fuel cell system, comprising a humidifier stack according to the embodiments which comprises at least one membrane enabling moisture transfer from a moist fluid flow to a dry fluid flow and which is installed between two end plates, in particular clamped. At least one of the end plates comprises at least one connector from the group comprising a supply connector for a dry fluid flow, a supply connector for a moist fluid flow, a discharge connector for a dry fluid flow and/or a discharge connector for a moist fluid flow. The supply connector for the dry fluid flow and the discharge connector for the dry fluid flow are connected in fluid communication to the second group of channels of the humidifier stack, comprising the dry gas channels. The supply connector for the moist fluid flow and the discharge connector for the most fluid flow are connected in fluid communication to the first group of channels of the humidifier stack, comprising the moist gas channels.

This first embodiment of the humidifier device according to the embodiments can be referred to as a variant without housing because the humidifier stack together with the end plates forms itself a housing. In relation to this first embodiment of the humidifier device, a humidifier stack is particularly suitable in which the plate stack forms supply and discharge channels which extend in the stacking direction and are connected in fluid communication to the at least two groups of flow channels. This embodiment of the humidifier stack, together with corresponding end plates, can be used without a housing, which is separate from or external to the humidifier stack, directly as a humidifier device because the supply and discharge of the dry and moist volume flows is enabled through a corresponding configuration within the plate stack.

In particular, a first supply channel as dry gas supply channel can be connected at the inlet side to the dry gas channels and a second supply channel as moist gas supply channel can be connected at the inlet side to the moist gas channels. As an alternative or in addition, a first discharge channel as dry gas discharge channel can be connected at the outlet side to the dry gas channels and a second discharge channel as moist gas discharge channel can be connected at the outlet side to the moist gas channels.

The respective supply and discharge channels are formed in particular by corresponding flow pockets in the frame plates and/or in the membranes which form the supply and discharge channels when stacked. The flow pockets can be understood as self-contained recesses in the structure of the frame plates and/or of the membranes which, stacked on each other in the stacking direction, form the supply and discharge channels extending in the stacking direction. The flow pockets are positioned in particular in a region which is lying outside of the moisture transfer surface.

The connectors, which are formed on at least one of the end plates and comprise a supply connector for a dry fluid flow, a supply connector for a moist fluid flow, a discharge connector for a dry fluid flow, and/or a discharge connector for a moist fluid flow, are thus advantageously in fluid contact with the supply and discharge channels provided by the plate stack itself, which, in turn, are in fluid communication with the at least two groups of flow channels of the humidifier stack.

This variant without a housing provides the advantage that, with minimal expenditure and at minimal costs, different performance variants of the humidifier device according to the embodiments can be provided because an increase or reduction of the number of plates is easily possible by means of which directly the membrane surface area is influenced. Thus, based on the same basic design, a whole range of application situations can be covered. Moreover, a further advantage resides in that, for the variant without a housing, installation space can be saved due to the high functional integration.

A further aspect of the embodiments concerns a humidifier device, in particular for a fuel cell system, with a housing which comprises a supply connector for a dry fluid flow, a supply connector for a moist fluid flow, a discharge connector for a dry fluid flow, and a discharge connector for a moist fluid flow. In the housing, a humidifier stack according to the embodiments is arranged which comprises at least one membrane enabling a moisture transfer from the moist fluid flow to the dry fluid flow. The supply connector for the dry fluid flow and the discharge connector for the dry fluid flow are connected in fluid communication to the second group of channels of the humidifier stack, comprising the dry gas channels, and the supply connector for the moist fluid flow and the discharge connector for the moist fluid flow are connected in fluid communication to the first group of channels of the humidifier stack, comprising the moist gas channels.

The second variant of the humidifier device according to the embodiments is a variant with housing. In this variant, the humidifier stack can comprise at least one housing seal present between the humidifier stack and the housing for mutual sealing of flow regions which are connected to the dry gas channels and moist gas channels of the humidifier stack. At least sections of the housing seal can be designed in this context for holding the humidifier stack mechanically in the housing and seal it relative to the housing at the same time.

In respect to possible embodiments of the housing seal, reference is being had to the application DE 10 2021 119 892.5, the contents of which is herewith incorporated by reference. The applicability of the housing seal disclosed in the aforementioned application to the embodiments is not impaired by the respective different inner construction of the plate stack.

Finally, a further aspect of the embodiments concerns a membrane for a humidifier stack according to the embodiments which enables a moisture transfer from a fluid flow guided in a moist gas channel to a fluid flow guided in a dry gas channel. The membrane is provided with an at least partially circumferentially extending seal which at least in sections can be brought into sealing contact at neighboring frame plates of a humidifier stack. The at least partially circumferentially extending seal comprises at least two flow channel seal sections which are present at two or more circumferential edges of a moisture transfer surface provided by the membrane at a first surface of the membrane. At least two other circumferential edges of the moisture transfer surface provided by the membrane are free of flow channel seal sections at the first surface. The flow channel seal sections are configured to seal in relation to a neighboring frame plate of the humidifier stack in order to form a flow channel of the humidifier stack in a region delimited by the membrane, by the neighboring frame plate of the humidifier stack, by a neighboring further membrane of the humidifier stack, and by the flow channel seal sections.

All features and feature combinations disclosed in relation to the subject matter embodiments “humidifier stack” as well as their specific advantages can be applied to the further subject matter embodiments “humidifier device” and “membrane,” and vice versa.

In embodiments, each of the frame plates may further include a support grid interposed between and connecting the at least one support element.

The at least one support element may further include one or more dimples disposed in the at least one support element and distributed along a length of the at least one support element, each of the one or more dimples being disposed into a top surface of the pressure bar, protruding from a bottom surface of the pressure bar and extending towards the plate base plane.

Each of the flow pocket seal and the at least partially circumferentially extending seal may include a left stopper portion, a right stopper portion, a middle hump portion interposed between the left stopper portion and the right stopper portion, the middle hump portion having a height higher than that of the left stopper portion and the right stopper portion, and at least one cavity interposed between the middle hump portion and each of the left stopper portion and the right stopper portion, through a top or bottom surface of a respective one of the flow pocket seal and the at least partially circumferentially extending seal.

### BRIEF DESCRIPTION OF DRAWINGS

Further advantages result from the following drawing description. In the drawings, the embodiments are illustrated. The drawings, the description, and the claims contain numerous features in combination. A person of skill in the art will consider the features expediently also individually and combine them to expedient further combinations.

FIG. 1 is an isometric view of a humidifier device according to the embodiments.

FIG. 2 is an isometric exploded view of the humidifier device.

FIG. 3 is a front view of the humidifier device.

FIG. 4 is a side view of the humidifier device.

FIG. 5 is longitudinal section A-A of FIG. 4.

FIG. 6a is detail view X of FIG. 5.

FIG. 6b is a detail view of FIG. 6a.

FIG. 7 is a plan view of a frame plate (moist side) of a humidifier stack according to the embodiments.

FIG. 8 is longitudinal section B-B of FIG. 7.

FIG. 9 is a plan view of a frame plate (dry side) of the humidifier stack.

FIG. 10 is longitudinal section F-F of FIG. 9.

FIG. 11 is longitudinal section C-C of FIG. 9.

FIG. 12 is a plan view of an alternative frame plate (dry side).

FIG. 13 is detail J of FIG. 12, the frame plate being installed in the humidifier stack.

FIG. 14 is a plan view of a membrane of the humidifier stack.

FIG. 15 is longitudinal section E-E of FIG. 12.

FIG. 16 is longitudinal section D-D of FIG. 12.

FIG. 17 is a plan view of an alternative membrane.

FIG. 18 is section L-L of FIG. 17, detail N.

FIG. 19 is section L-L of FIG. 17, detail N, the membrane being installed in the humidifier stack.

FIG. 20 is an isometric view of a humidifier stack according to other embodiments.

FIG. 21 is an isometric view of a humidifier device according to other embodiments.

FIG. 22 is an isometric view of another alternative frame plate (dry side).

FIG. 23 is an isometric view of still another alternative frame plate (dry side).

FIG. 24 is detail view X of FIG. 23.

FIG. 25 is an isometric view of another alternative membrane.

FIG. 26 is a cross-sectional diagram of an alternative seal adjacent to the other alternative membrane of FIG. 25, as the seal is compressed for a distance s1.

FIG. 27 is a cross-sectional diagram of the alternative seal adjacent to the other alternative membrane of FIG. 25, as the seal is compressed for a distance s greater than the distance s1.

### DETAILED DESCRIPTION

In the Figures, same or same-type components can be provided with same reference characters. The Figures show only examples and are not to be understood as limiting.

Directional terminology used in the following with terms such as “left”, “right”, “top”, “bottom”, “in front of”, “behind”, “after”, and the like serve only for better understanding of the Figures and are not to be understood in any case as a limitation of the generality. The illustrated components and elements, their design and use can vary in the context of considerations of a person of skill in the art and adapted to the respective applications.

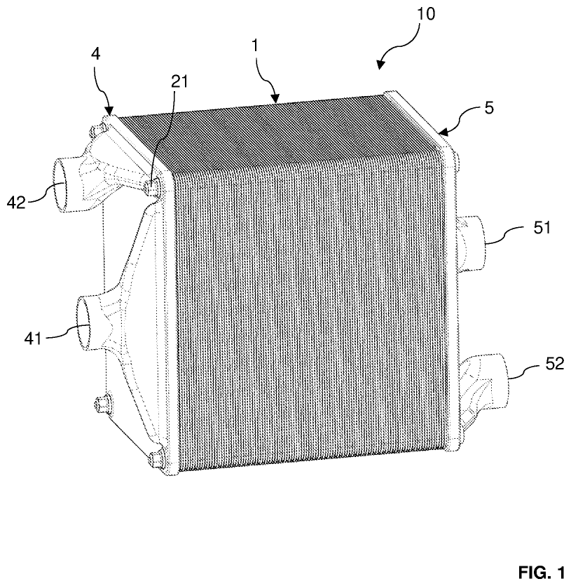

In FIG. 1, a humidifier device 10 according to the embodiments is illustrated in an isometric view. The humidifier device 10 comprises a humidifier stack 1 which is also in accordance with the embodiments and which is mounted between two end plates 4, 5. End plates 4, 5 and humidifier stack 1 are held together by threaded rods acting as clamping force generating device 2, wherein the pretension force is generated by removable nuts 21. The end plates 4, 5 provide corresponding connectors connectable to neighboring system components in order to make available to the humidifier stack the fluid flows provided for the moisture exchange. In the end plate 4 to the left in the illustration, a supply connector for a moist fluid flow 42 as well as a supply connector for a dry fluid flow 41 are formed. In the end plate 5 to the right in the illustration, a discharge connector for a dry fluid flow 51 as well as a discharge connector for a moist fluid flow 52 are formed. The respective fluid flows are guided via the end plates 4, 5 to the dry or moist gas channels which are formed in the humidifier stack 1 and are separated in the humidifier stack 1 by a membrane, respectively, which enables a moisture transfer from the moist gas channel to the dry gas channel.

In the mounted state in a fuel cell system, the supply connector for a moist fluid flow 42 is connected to a conduit coming from the exhaust gas side of the fuel cell stack and the supply connector for a dry fluid flow 41 is connected to a fresh gas intake conduit, in general downstream of a cathode air filter.

The discharge connector for a dry fluid flow 51 is connected to a cathode air conduit leading to the fuel cell stack and the discharge connector for a moist fluid flow 52 leads in the end into the environment, wherein frequently also further system components can be arranged upstream, for example, a water separator and/or at least one turbine of a cathode air compression device.

Within the humidifier stack 1, the respective fluid flows are guided in crossflow relative to each other; this is apparent already from the positioning of the respective connectors 41, 42, 51, 52 at the end plates 4, 5.

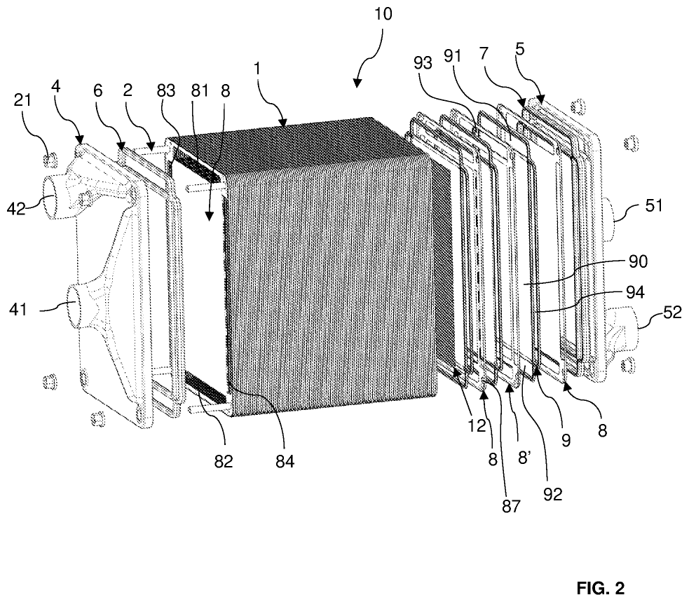

In the isometric view of FIG. 2, the humidifier device 10 according to the embodiments is illustrated in an exploded view, wherein the separation between humidifier stack 1 and frame plates 4, 5 can be seen well. At its axial end viewed in the stacking direction, the humidifier stack 1 is sealed relative to the end plates 4, 5 by an end plate seal 6, 7, respectively. The unit of end plates 4, 5 and humidifier stack 1 is held together by a total of four threaded rods acting as clamping force generating device 2 and guided through corresponding passage openings in the humidifier stack 1.

The humidifier stack 1 comprises an alternatingly stacked configuration comprising frame plates 8 of the moist side, frame plates 8′ of the dry side, and membranes 9 arranged between the respective frame plates. The membranes 9 are embodied separate from the frame plates 8, 8′ and are held in the plate stack exclusively by clamping action.

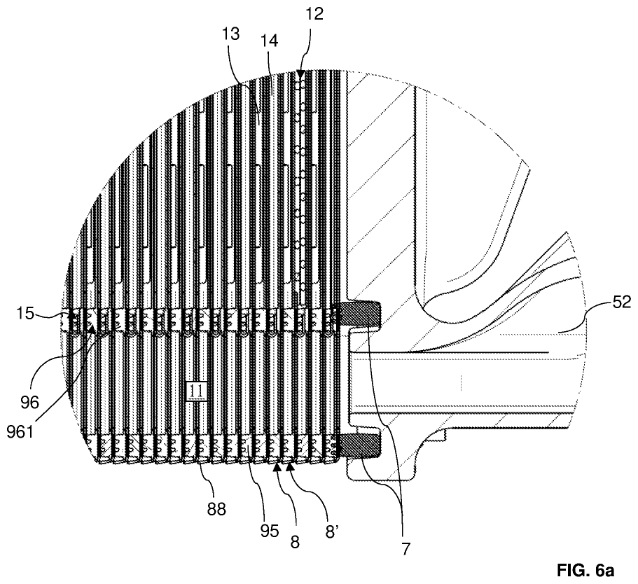

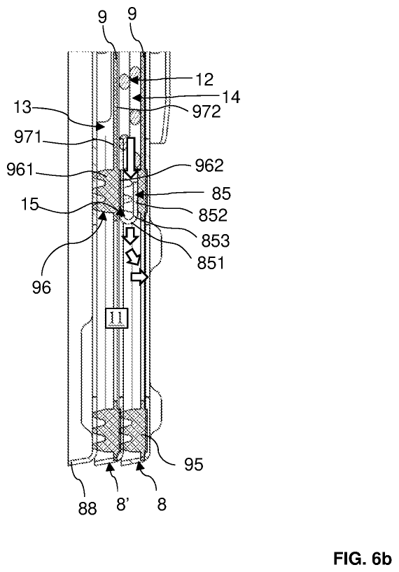

In the humidifier stack 1, moist gas channels 14 (see FIGS. 6a, 6b), each comprising an inflow cross section 16 as well as an outflow cross section 15, and dry gas channels 13 (see FIGS. 6a, 6b), also each comprising an inflow cross section 16 as well as an outflow cross section 15, are formed. The respective inflow cross sections 16 as well as outflow cross sections 15 of the moist gas channels 14 and dry gas channels 13 are in fluid communication with supply/discharge channels 11 which are formed by the plate stack itself by flow pockets 81, 82, 83, 84 formed in the frame plates 8, 8′ as well as by flow pockets 91, 92, 93, 94 formed in the membranes 9, which, in the stacked state, form the supply/discharge channels 11 extending in the stacking direction. The channel formed by the flow pocket 81 is the moist inlet which is connected to the moist gas channels 14 at the inlet side. The channel formed by the flow pocket 84 is a dry inlet that is connected to the dry gas channels 13 at the inlet side. The channel formed by the flow pocket 82 is the moist outlet which is connected at the outlet side to the moist gas channels 14. The channel formed by the flow pocket 83 is a dry outlet which is connected at the outlet side to the dry gas channels 13.

Between two membranes 9 which are neighboring each other in the plate stack, a membrane support element 12 is present that spans across a moisture transfer surface 90 provided by the membrane 9. The membrane support element 12 supports the membrane 9 against differential pressures acting thereon in operation so that the latter does not become damaged. The membrane support element 12 acts however at the same time also as flow mixer which influences the flow in the respective moist gas channel 14 and/or dry gas channel 13 and in particular ensures that mixing of the flow in the stacking direction is realized, for which purpose this flow mixer is designed in particular as a laminar mixer. The membrane support element 12 is in particular a flow grid extending in two different directions in the plane and comprises a number of webs crossing each other. In the exploded view of the humidifier device 10 or of the humidifier stack 1 illustrated in FIG. 2, the membrane support element 12 is a device component which is separate from the frame plates 8, 8′. In embodiments, not illustrated, the membrane support element 12 can however also be integrated in the frame plates 8, 8′ and in particular be provided as one piece together with a respective frame plate 8, 8′. For this purpose, sheet steel as a starting material for the frame plates 8, 8′ provides best preconditions.

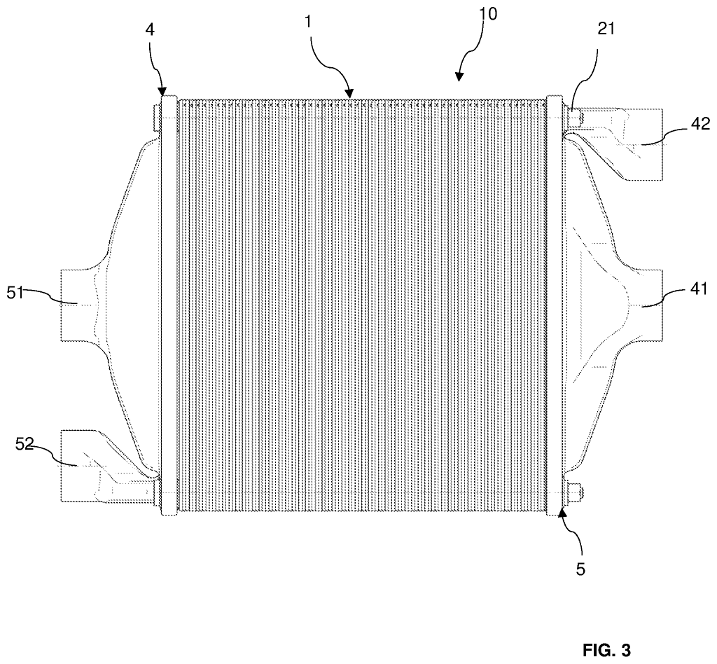

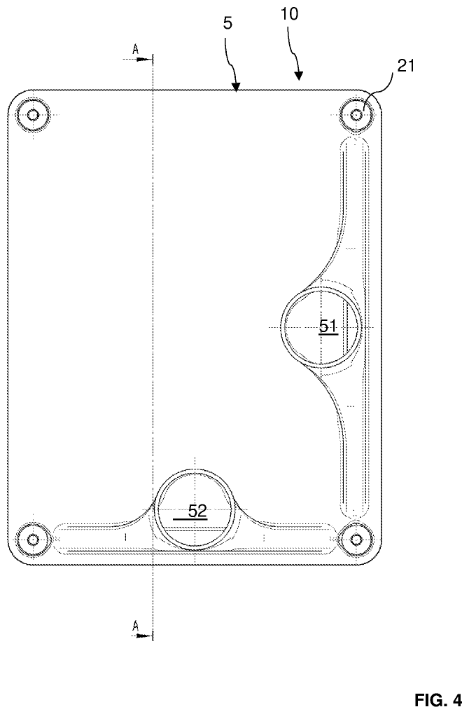

In FIG. 3 and FIG. 4, the humidifier device 10 of FIG. 1 is shown in two different projected views; FIG. 3 shows it from the rear and FIG. 4 from the right.

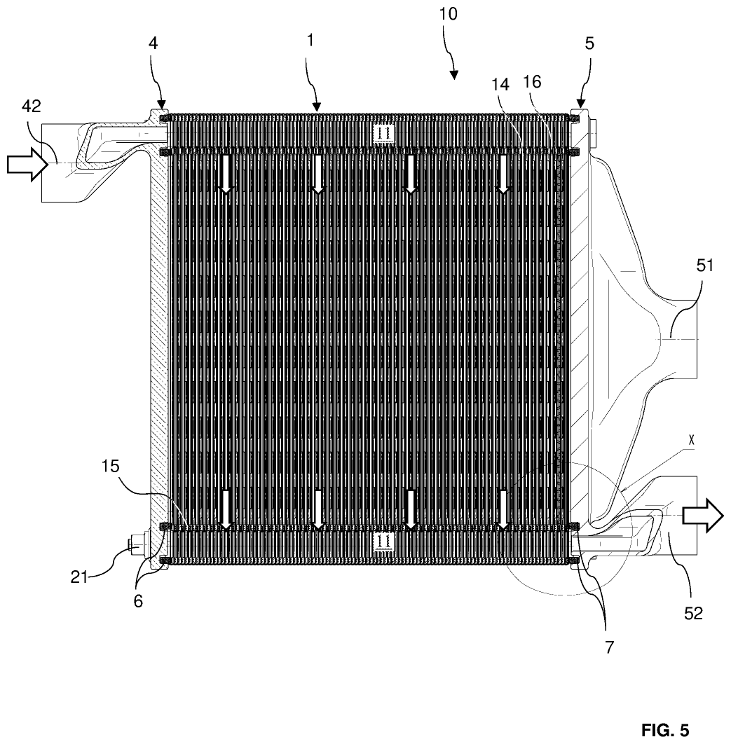

FIG. 5 shows the humidifier device 10 in longitudinal section A-A of FIG. 4, wherein in particular the sealing action of the humidifier stack 1 relative to the end plates 4, 5 by the end plate seals 6, 7 as well as the sealing locations at both sides can be seen well in this illustration. The sectioned top channel 11 is the supply channel for moist fluid formed by the flow pockets 81 of the frame plates 8, 8′ as well as the flow pockets 91 of the membranes 9. The bottom channel 11 illustrated in the Figure is the discharge channel for moist fluid formed by the flow pockets 82 of the frame plates 8, 8′ as well as the flow pockets 92 of the membranes 9. The supply and discharge channels 11 are connected in fluid communication with the moist gas channels 14 which are formed by the plate construction of the humidifier stack 1, wherein a flow from the top supply channel 11 to the bottom discharge channel 11 is provided in operation of the humidifier device 10.

The connection of the dry gas channels 13 to the corresponding supply and discharge channels 11 can however not be seen in the section view of FIG. 5 because they extend rotated by 90°. Functionally, it corresponds however to the afore described connection of the moist gas channels 14.

In the detail view illustrated in FIG. 6a which shows the detail X of FIG. 5, a region of the humidifier device 10 close to the moist fluid outlet is illustrated in section view in which the inner construction of the humidifier stack 1 as well as its connection to the end plate 5 can be seen.

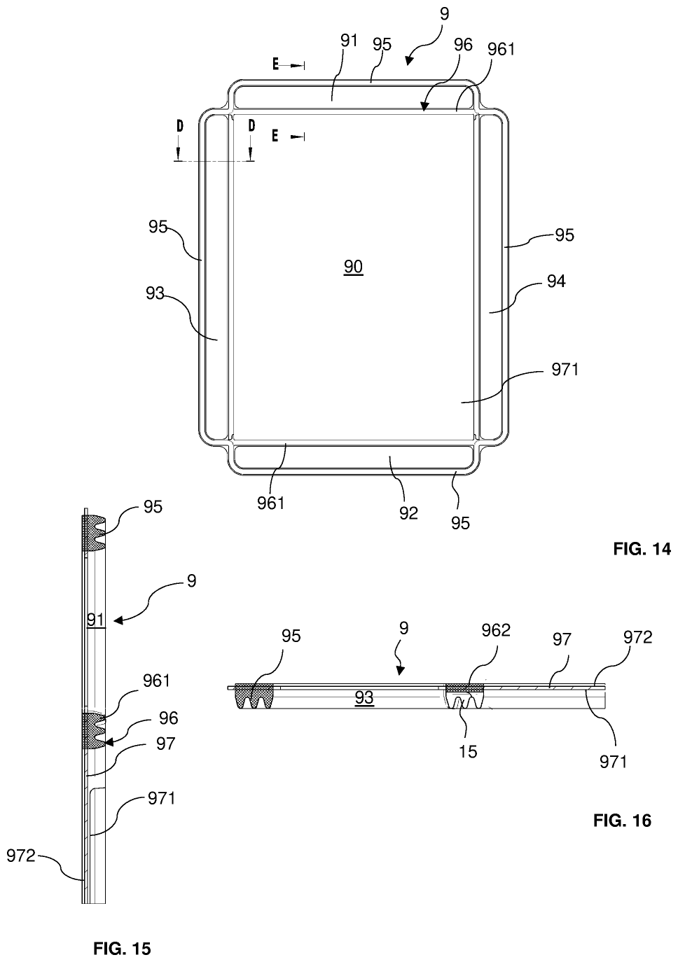

The humidifier stack 1 comprises alternatingly stacked moist-side frame plates 8, membranes 9, as well as dry-side frame plates 8′. In a region circumferentially extending about the moisture transfer surface 90 (see FIG. 14), the membranes 9 are provided with an at least partially circumferentially extending seal 96. At two oppositely positioned circumferential edges of the moisture transfer surface 90 at a first surface 971 of the membrane 9, the at least partially circumferentially extending seal 96 comprises a respective flow channel seal section 961. At least two other circumferential edges of the moisture transfer surface 90 provided by the membrane 9 are free of flow channel seal sections 961 at the first surface 971.

The flow channel seal sections 961 now seal in relation to a neighboring frame plate 8, 8′ in order to form one of the flow channels 13, 14 in a region which is delimited by the membrane 9, by the neighboring frame plate 8, 8′, by a neighboring further membrane 9, and the flow channel seal sections 961.

The other circumferential edges of the moisture transfer surface 90 provided by the membranes 9 which are free of flow channel seal sections 961 at the first surface 971 provide respective inflow cross sections 16 and outflow cross sections 15 into the flow channels 13, 14.

In case of membranes 9 neighboring each other, the circumferential edges of the moisture transfer surface 90 of the membrane 9 at which the flow channel seal sections 961 are present are thus alternatingly different ones in order to realize an alternating sequence of moist gas channels 14 and dry gas channels 13 in the plate stack.

In the illustration of FIG. 6a, the connection of the moist-side discharge channel 11 to the outflow cross sections 15 of the moist gas channels 14 is illustrated. In the illustrated rim region of the moisture transfer surface 90, the circumferential edges of every other membrane 9 at the first surface 971 are free of flow channel seal sections so that an outflow out of the moist gas channels 14 can be realized. In the illustrated rim region of the moisture transfer surface 90 of this circumferential edge, the interposed membranes 9 have flow channel seal sections 961 so that an outflow out of the dry gas channels 13 into the moist-side discharge channel 11 is prevented. In the dry gas channels 13, the flow is rather in a direction oriented into the illustration plane so that a flow guiding action in crossflow results in the dry gas channels 13 and moist gas channels 14.

The moist-side discharge channel 11, which is formed in the stacking direction by the flow pockets 82 of the frame plates 8, 8′ as well as the flow pockets 92 of the membranes 9, is delimited at its outer side by a flow pocket seal 95 which is formed at the membrane 9 and seals the moist-side discharge channel 11 relative to the environment. The flow pocket seal 95 is effective bidirectionally, i.e., seals relative to frame plates 8, 8′ neighboring at both sides. In order to provide a protection of the flow pocket seal 95, the frame plates 8, 8′ have at their outer circumference a collar 88, respectively, which, in the clamped state of the plate stack, contacts the respective neighboring frame plate 8, 8′ and provides a substantially closed outer wall of the humidifier stack 1 in this way. The collar 88 is bent at an angle smaller than 90° relative to the plate base plane so that its distal end, when contacting a neighboring frame plate 8, 8′, does not form a hard stop but provides still sufficient movement play in the stacking direction so that the at least partially circumferentially extending seal 96 can be reliably compressed. A hard stop of the collar 88 is moreover undesirable because this can result in undefined relative positions of neighboring frame plates 8, 8′ in relation to the stacking direction which can lead to tolerance problems or partially incomplete seal compression.

Based on FIG. 6b, which as a detail of FIG. 6a shows three frame plates 8, 8′ as well as two membranes 9, the function of the embodiments is even better understood. In particular, the connection of the moist gas channel 14 to the moist-side discharge channel 11 is made clear with the aid of flow arrows. The flow, as explained, is enabled in that the moisture transfer surface of the membrane 9 at the circumferential edge illustrated in the Figure is free of flow channel seal sections 961 so that a flow can occur through the flow openings 851 of the support element 85. The neighboring membrane 9, on the other hand, has at the illustrated circumferential edge of its moisture transfer surface a flow channel seal section 961 so that the outflow into the moist-side discharge channel 11 is prevented here.

Of course, it is understood that all features and properties of the humidifier stack 1, which have been explained in an exemplary fashion for the connection of the moist gas channels 14 to the moist-side discharge channel 11 with the aid of FIG. 5 and FIG. 6a as well as FIG. 6b, can be applied also mutatis mutandis to the connection of the moist gas channels 14 to the moist-side supply channel 11 as well as to the connection of the dry gas channels 13 to the dry-side supply and discharge channels.

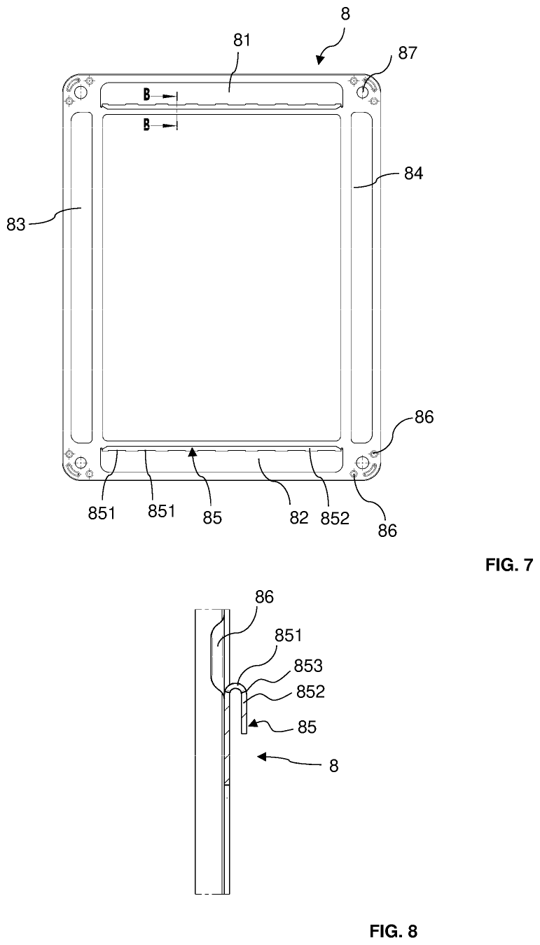

In FIG. 7, a plan view of a moist-side frame plate 8 is illustrated while FIG. 8 shows the section B-B. In the assembled state, the flow path of the moist fluid, in relation to the illustration, is from top to bottom. The inflow is realized through the flow pocket 81 which forms the moist-side supply channel 11 in the stacked state while the outflow in analogy is realized via the flow pocket 82. In order to enable inflow into the moist gas channel 14, the support elements 85 formed as pressure bars 852 have flow openings 851 which connect the region of the respective supply/discharge channel 11 provided by the flow pockets 81, 82 to the moist gas channel 14.

The pressure bars 852 are each formed as one piece with the material of the frame plate 8, in particular as a bent edge, wherein the flow openings 851 can be punched. During assembly, the pressure bars 852 contact a second surface of a neighboring membrane 9, more precisely stated the region of a circumferential edge of the moisture transfer surface 90 provided by the membrane 9 at which no flow channel seal sections are present. Due to the full surface contact of the second surface 971 of the membrane 9 at the pressure bar 852, an optimal support of the membrane 9 is achieved and rippling is prevented. In the section B-B of FIG. 8, a pressure bar 852 is illustrated in a state of deformation corresponding to the clamped installation in the plate stack. In principle, the pressure bar 852 is however elastically springy so that the latter, in the uninstalled initial state of the frame plate 8, does not extend parallel to the plate base plane but is slightly angled relative thereto for providing a sufficient deformation travel. This state is illustrated for a dry-side frame plate 8′ in FIG. 11, wherein this can be applied in analogy to the moist-side frame plate 8, however.

The passage openings 87 are provided for receiving the threaded rods or a comparable clamping force generating device.

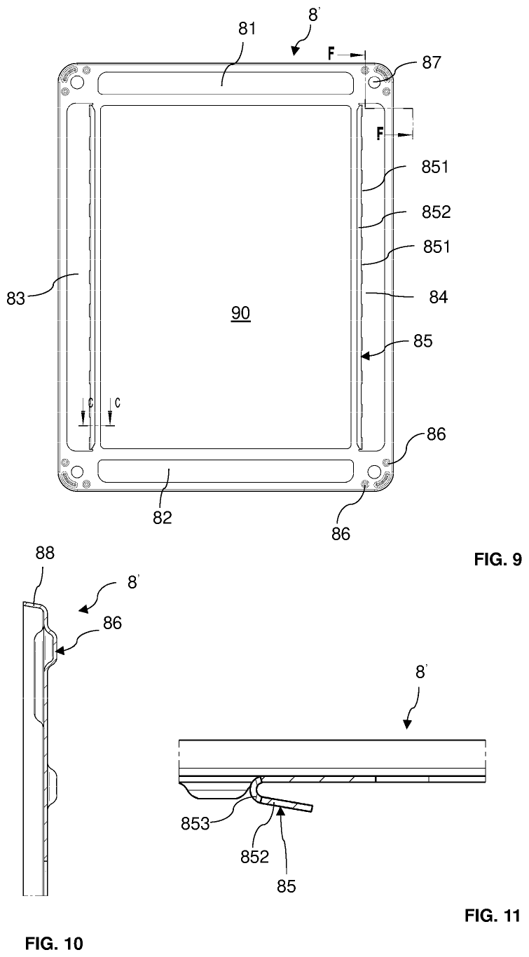

The frame plate 8′ of the dry side, illustrated in FIG. 9, FIG. 10, and FIG. 11, is constructed in analogy to the moist-side frame plate 8. However, there is the difference that the support elements 85 formed as pressure bar 852 are formed at different oppositely positioned edges in order to provide a flow path, which is separated from the moist side, for the dry side. When assembled, an inflow of dry fluid through the flow pocket 84 is realized which forms the dry-side supply channel 11 in the stacked state while the outflow is realized in analogy through the flow pocket 83.

In the section F-F illustrated in FIG. 10, the compression limitation elements 86 present in the corner regions of the frame plate 8′ can be seen which are formed as locally deep-drawn regions of the plate material, respectively. In the clamped state of the plate stack, the compression limitation elements 86 contact a neighboring frame plate 8 in order to form a “hard” stop and therefore predefine a predetermined seal compression which has a positive effect on the length tolerances in the stacking direction.

In FIG. 11, the uncompressed initial state of the pressure bar 852 is illustrated. As can be seen, the pressure bar 852 extends at an angle in relation to the plate base plane. When assembling the plate stack, the pressure bar 852 is elastically deformed (bending) until it extends parallel to the plate base plane. This springy deformation correspondingly stores the clamping forces and can therefore compensate settling effects in the flow channel seal sections 961 of the at least partially circumferentially extending seal 96.

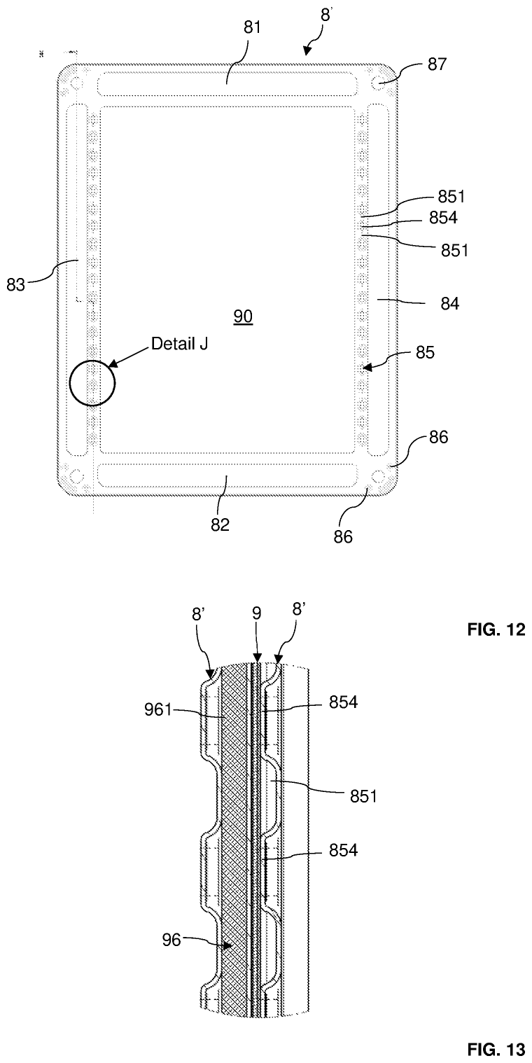

FIG. 12 shows an alternative embodiment of a dry-side frame plate 8′ in which the support elements 85 are not embodied as pressure bars but as domed support portions 854. The domed support portions 854 can be deep drawn from a sheet metal material of the frame plate 8′ in a simple and reliable manner. Along two oppositely positioned edges of the frame plate 8′, a plurality of domed support portions 854 are arranged spaced apart from each other, between which respective flow openings 851 are formed which enable inflow in and outflow from the respective flow channel of the humidifier stack. In a state installed in the humidifier stack, the sections of the domed support portions 854 spaced from the plate base plane of the frame plate 8′ are supported on a neighboring membrane 9, which is illustrated in FIG. 13. In other respects, the stack construction is identical to the embodiment with pressure bars. A configuration of the support elements 85 as domed support portions 854 is one possibility which is to be realized as needed with a reduced apparatus expenditure in the production in comparison to the bent pressure bars because a bending and punching step is eliminated.

In FIG. 14, FIG. 15, and FIG. 16, finally the membrane 9 itself is illustrated which represents the core component of the humidifier stack 1 at which the moisture transfer takes place. The membrane 9 comprises a moisture transfer surface 90 which is provided at two oppositely positioned circumferential edges at a first surface 971 with a respective flow channel seal section 961, comprising a plurality of seal lips. The flow channel seal sections 961 interact in the afore described manner with a neighboring frame plate 8, 8′ in order to laterally delimit the flow channel, i.e., dry gas channel 13 or moist gas channel 14, formed between the first surface 971 of the membrane 9 and the neighboring frame plate 8, 8′.

In the illustrated exemplary embodiment of the membrane 9, the first surface 971 bordered a dry gas channel 13, i.e., the flow was realized in the illustration from left to right. In the illustrated exemplary embodiment of the membrane 9, the flow channel seal sections 961 are present at oppositely positioned short circumferential edges of the moisture transfer surface 90 (see section E-E).

At the long circumferential edges of the moisture transfer surface 90, the first surface 971 of the membrane 9, on the other hand, is free of flow channel seal sections 961 in order to enable the inflow and outflow of the dry fluid flow (see section D-D).

The flow channel seal sections 961 of the at least partially circumferentially extending seal 96 are connected by injection molding to the moisture transfer medium 97 of the membrane 9 but can also be adhesively connected in other embodiments. The seal material of the flow channel seal sections 961 is injection-molded so as to engage around the respective circumferential edge and forms a secondary seal 962 embodied as a flat seal at the second surface 972 of the membrane 9 facing away from the first surface 971. Upon assembly, this secondary seal 962 contacts the support elements 85, in particular the pressure bars 852, of a neighboring frame plate. On the one hand, this protects the moisture transfer medium 97 of the membrane 9 from abrasion and, on the other hand, improves “anchoring” of the sealing material.

In a region which is lying outside of the moisture transfer surface 90, the membrane 9 is provided with a flow pocket seal 95, surrounding at the exterior side the flow pockets 91, 92, 93, 94 and forming seal lips at the first surface 971 and configured as a flat seal at the second surface 972. Upon installation, the flow pocket seal 95 seals bidirectionally in relation to neighboring frame plates 8, 8′ and thus closes off the supply/discharge channels 11, which are formed in the stacked state by the flow pockets 91, 92, 93, 94, in relation to the environment.

As is apparent based on the afore described flow regime, the illustrated membrane 9 is a dry-side membrane which is correlated with a dry-side frame plate 8′ (see FIG. 9). A moist-side membrane 9 (not illustrated) is however of an analog configuration, wherein however there is the difference that the flow channel seal sections 961 thereof are not present at the short sides but at oppositely positioned long circumferential edges of the moisture transfer surface 90 at the first surface 971 of the membrane 9 in order to enable correspondingly a flow, in relation to the illustration, from the top to the bottom.

The moisture transfer medium 97 of the membrane 9 comprises a film of PTFE or PFSA. The film is framed or laminated sandwich-like between two nonwoven layers, in particular of PET, PPS, or PA. The advantage of this lamination resides in that the film, which is very thin and therefore difficult to handle and mechanically not very robust, is protected. Moreover, the nonwoven facilitates at the surface the attachment of the at least partially circumferentially extending seal 96 or the flow channel seal sections 961 because the film has a very slick surface and therefore is not well suited as point of attack for joining methods. The nonwoven, on the other hand, comprises a porous or rough structure and is therefore significantly better suited for joining.

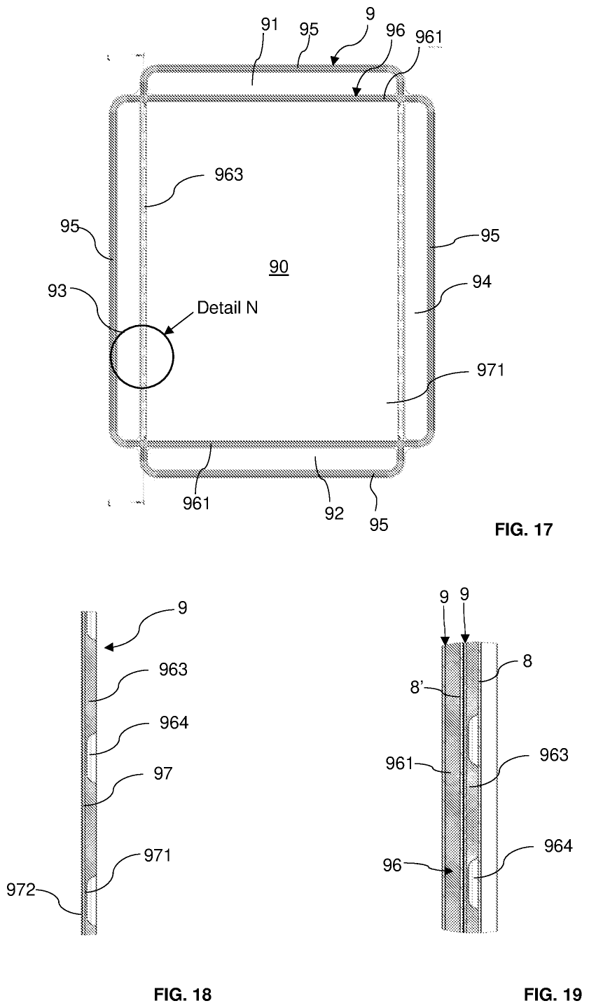

In FIGS. 17 and 18, an alternative membrane 9 is illustrated in a plan view. The membrane 9 comprises integrated membrane-side support elements 963 which are formed as elevations or knobs. A plurality of elevations or knobs arranged spaced apart are provided which are present along two oppositely positioned circumferential edges of the moisture transfer surface 90 of the membrane 9. Flow channel seal sections 961 are present at two further circumferential edges of the moisture transfer surface 90 of the membrane 9. The illustrated membrane 9 is a dry-side membrane 9 which in relation to its inflow and outflow regime corresponds to the membrane illustrated in FIG. 14. The membrane-side support elements 963 are present at the same surface 971 of the membrane 9 at which also the flow channel seal sections 961 are present. The membrane-side support elements 963 are present in particular at the first surface 971 of the membrane. The membrane-side support elements 963 can be provided alternatively or additionally to frame plate-side support elements (pressure bars or domed pressure portions). The membrane-side support elements 963 provide an advantageous possibility of providing support elements with a minimal expenditure in regard to the production.

Between the membrane-side support elements 963, flow openings 964 are formed that open into one of the flow channels of the at least two groups of flow channels of the humidifier stack. The membrane-side support elements 963 can be supported at a neighboring frame plate 8, 8′; this is illustrated in FIG. 19. The membrane-side support elements 963 can be comprised of the same material as the flow channel seal sections 961 and can be produced in a common process step together with the flow channel seal sections, in particular by injection molding to the moisture transfer medium of the membrane 9.

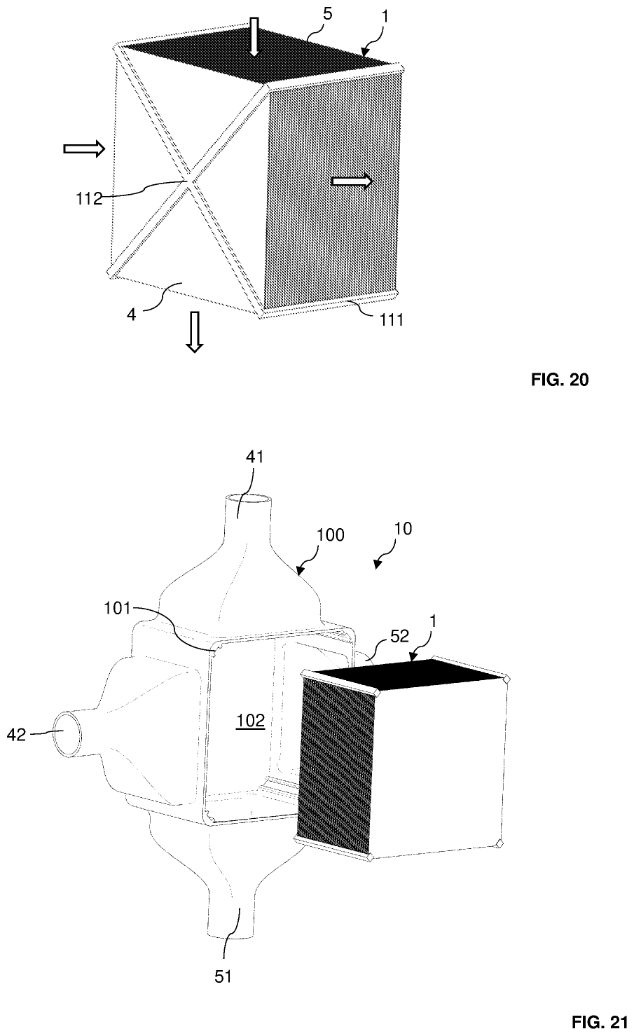

In FIG. 20, other embodiments of the humidifier stack 1 is illustrated that differs from the first embodiment in that it has no integrated supply/discharge channels for moist and dry fluid flows. This is achieved by eliminating the flow pockets 81, 82, 83, 84 of the frame plates 8, 8′ as well as the flow pockets 91, 92, 93, 94 of the membranes 9. The inner structure of the plate stack is however otherwise identical. The respective inflow cross sections as well as outflow cross sections of the dry and/or moist gas channels are exposed at the side faces of the humidifier stack 1 and are connected in fluid communication only upon installation in a corresponding housing with corresponding supply/discharge connectors. While the first embodiment requires no separate housing, the second embodiment requires one.

The plate stack forming the humidifier stack 1 is again clamped between two end plates 4, 5. At a first pair of oppositely positioned side faces, inflow cross sections into the dry gas channels, on the one hand, and outflow cross sections out of the dry gas channels, on the other hand, are present. At a second pair of oppositely positioned side faces, inflow cross sections into the moist gas channels, on the one hand, and outflow cross sections out of the moist gas channels, on the other hand, are present. Thus, there is again provided a flow through the humidifier stack in crossflow.

In order to be able to separately guide the respective fluid flows—dry inlet, dry outlet, moist inlet, moist outlet—respective housing seals 111 are present at the edges of the plate stack positioned between the side faces and seal the respective side faces from each other in the installed state. The housing seals 111 can be designed as flat seals which act radially in the mounted state. The plate stack can comprise a respective bevel in its corner regions, in particular by about 45°, so that a fastening surface for the housing seals 111 is provided. The housing seals 111 can be glued to the plate stack, for example. The housing seals 111 extend each to the respective end plates 4, 5 and meet each other there in the form of a seal cross 112 present at the respective end plate 4, 5 which, in the installed state, seals axially relative to a corresponding wall of the housing 100.

An installed state of the humidifier stack 1 in a humidifier device 10 according to a second embodiment is illustrated in FIG. 21. The humidifier device 10 comprises a housing 100 with a receiving space 102 configured to receive the humidifier stack 1. The housing 100 comprises furthermore a supply connector for a dry fluid flow 41, a supply connector for a moist fluid flow 42, a discharge connector for a dry fluid flow 51, and a discharge connector for a moist fluid flow 52 which are each connected in fluid communication to the receiving space 102. The housing 100 comprises four housing seal grooves 101 adjoining the receiving space 102 in which the housing seals 111 of the humidifier stack are received sealingly in the installed state. The housing seal grooves 101 are arranged respectively in corner regions of the receiving space 102. The housing seal grooves 101 each have a groove base which can act as radial seal surface and which is positioned at a slant relative to a main flow direction (dry or moist), in particular slanted at 45°. The housing seal grooves 101 comprise parallel groove walls delimiting the groove base at both sides and guiding the humidifier stack 1 during the installation along the installation direction. The position and arrangement of the supply/discharge connectors 41, 42, 51, 52 is only an example and can deviate in embodiments.

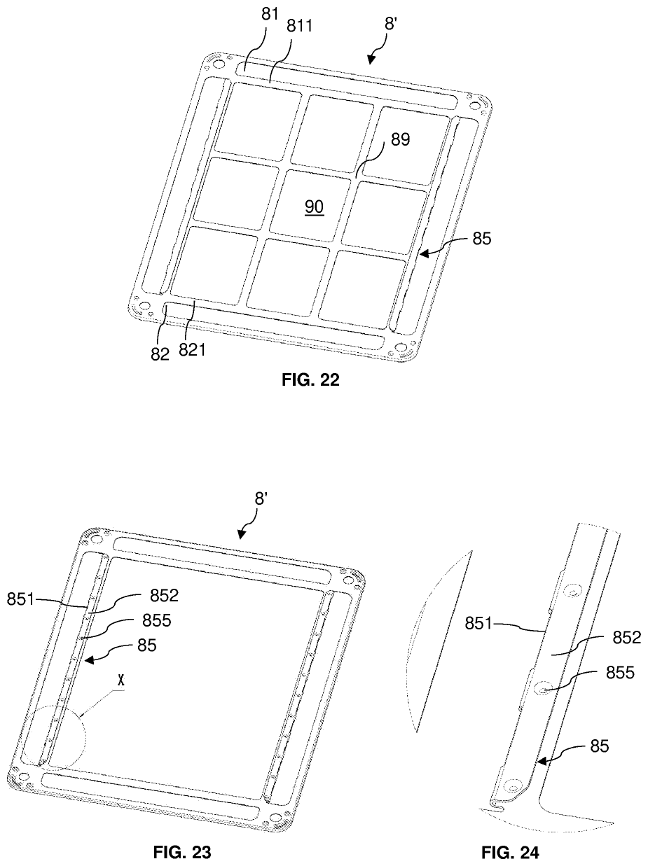

FIG. 22 is an isometric view of another alternative frame plate 8′ (dry side). The frame plate 8′ further includes a support grid 89 interposed between and connecting the support elements 85 and interposed between and connecting circumferential edges 811 and 821 of the flow pockets 81 and 82. The support grid 89 is further disposed over or under the moisture transfer surface 90 of the neighboring membrane 9.

The support grid 89 may be formed as one piece with a material of the frame plate 8′, through which openings can be punched. During assembly, the support grid 89 may contact the moisture transfer surface 90 of the neighboring membrane 9, and due to this contact, an optimal support of the membrane 9 can be achieved and rippling may be prevented. As a result, better positioning of the membrane 9 and the at least partially circumferentially extending seal 96 on the frame plate 8′ can be achieved, reducing pressure loss in the humidifier device 10. The support grid 89 is illustrated for the dry-side frame plate 8′ in FIG. 22, but may be applied in analogy to the moist-side frame plate 8 in FIG. 7.

FIG. 23 is an isometric view of still another alternative frame plate 8′ (dry side). FIG. 24 is detail view X of FIG. 23. The support element 85 further includes one or more dimples 855 disposed in the support element 85 and distributed evenly along a length of the support element 85. In detail, each of the dimples 855 is disposed into a top surface of the pressure bar 852, protrudes from a bottom surface of the pressure bar 852 and extends towards the plate base plane of the frame plate 8′.

The dimples 855 may be formed as one piece with the material of the frame plate 8′. During assembly, the pressure bar 852 contacts the second surface of the neighboring membrane 9 to achieve an optimal support of the membrane 9 and to prevent rippling. However, if too much pressure is applied to the pressure bar 852, it may contact the frame plate 8′, causing the corresponding flow opening 851 to be blocked. The dimples 855 prevent this from occurring by contacting the frame plate 8′ and maintaining a space between the pressure bar 852 and the frame plate 8′, preventing the corresponding flow opening 851 from being blocked and thus reducing pressure loss in the humidifier device 10. The dimples 855 are illustrated for the dry-side frame plate 8′ in FIGS. 23 and 24, but may be applied in analogy to the moist-side frame plate 8 in FIG. 7.

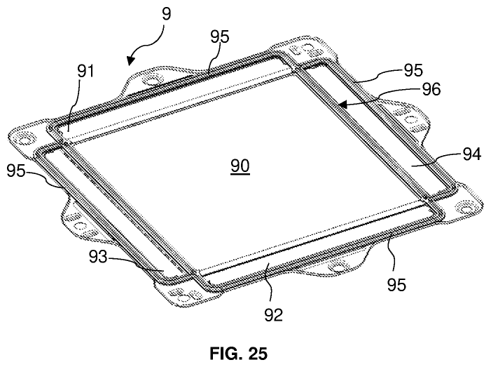

FIG. 25 is an isometric view of another alternative membrane 9.

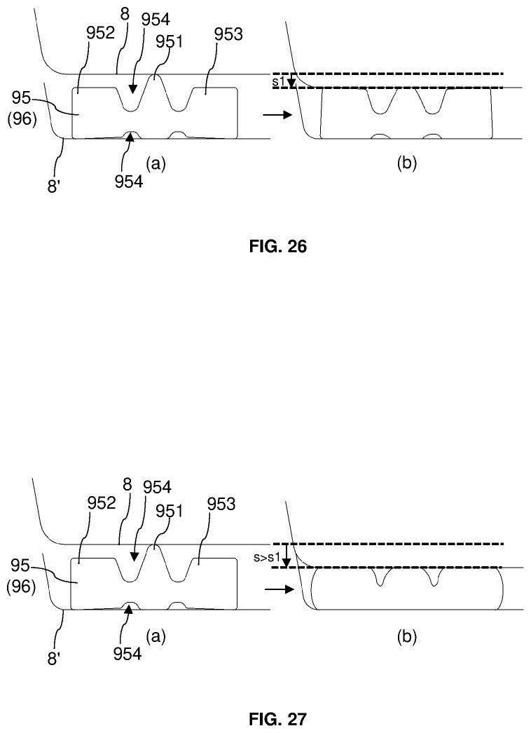

Referring to FIGS. 25 and 26, an alternative flow pocket seal 95 and an alternative at least partially circumferentially extending seal 96 are fixedly connected to the membrane 9. In detail, the flow pocket seal 95 is fixedly connected to a region externally surrounding the flow pockets 91, 92, 93, 94, and the at least partially circumferentially extending seal 96 is disposed along the circumferential edges of the moisture transfer surface 90 of the membrane 9 at the first surface 971 of the membrane 9, as similarly described with respect to FIG. 14. The illustrated membrane 9 is a moist-side membrane corresponding to a moist-side frame plate 8 of FIG. 7. A dry-side membrane 9 (not illustrated) is however of an analog configuration, in which there is a difference that the seal 96 thereof is not present at long sides but at oppositely positioned short circumferential edges of the moisture transfer surface 90 to enable correspondingly a flow, in relation to the illustration, from left to right.

However, the flow pocket seal 95 and the at least partially circumferentially extending seal 96 of FIGS. 25 and 26 are different than those of FIG. 14 in that each of the flow pocket seal 95 and the at least partially circumferentially extending seal 96 of FIGS. 25 and 26 has a different geometry of which a middle hump portion has a height higher than that of a left stopper portion and a right stopper portion.

FIG. 26 is a cross-sectional diagram of an alternative seal 95 or 96 adjacent to the other alternative membrane 9 of FIG. 25, as the seal 95 or 96 is compressed for a distance s1. FIG. 27 is a cross-sectional diagram of the alternative seal 95 or 96 adjacent to the other alternative membrane 9 of FIG. 25, as the seal 95 or 96 is compressed for a distance s greater than the distance s1.

Referring to portion (a) of FIG. 26 and portion (a) of FIG. 27, the seal 95 or 96 includes a middle hump portion 951, a left stopper portion 952 and a right stopper portion 953 and cavities 954. The middle hump portion 951 is interposed between the left stopper portion 952 and the right stopper portion 953, and has a height higher than that of the left stopper portion 952 and the right stopper portion 953, namely, a height difference between the middle hump portion 951 and the left stopper portion 952 or the right stopper portion 953 is the distance s1. The cavities 954 are interposed between the middle hump portion 951 and each of the left stopper portion 952 and the right stopper portion 953, respectively through top and bottom surfaces of the seal 95 or 96. The seal 95 or 96 is interposed between and contacting the frame plates 8, 8′, initially, only the middle hump portion 951 contacting the frame plate 8 above the seal 95 or 96. The middle hump portion 951 has a contact surface smaller than each of the left stopper portion 952 and the right stopper portion 953.

Referring to portion (b) of FIG. 26, during assembly, the frame plate 8 first axially compresses the middle hump portion 951 of the seal 95 or 96 for the distance s1. A first reaction force (a first force-displacement curve) of the middle hump portion 951 for the distance s1 is relatively very small and increases at a first rate that is relatively small, keeping deformations in the thin frame plates 8, 8′ as low as possible. Due to decoupling of the middle hump portion 951 with each of the left stopper portion 952 and the right stopper portion 953 (the cavities 954), the first reaction force is not affected by the two massive stopper portions 952 and 953. Further, due to the smaller contact surface of the middle hump portion 951, the seal 95 or 96 provides high surface pressures, even at low forces, to achieve a very good sealing effect. In addition, the seal 95 or 96 and thus the frame plates 8, 8′ are stabilized against tilting.

Referring to portion (b) of FIG. 27, during assembly, the frame plate 8 then axially compresses the seal 95 or 96 for the distance s greater than the distance s1, namely, the left stopper portion 952 and the right stopper portion 953. A second reaction force (a second force-displacement curve) of the left stopper portion 952 and the right stopper portion 953 increases at a second rate much larger than the first rate. This results in a bilinear force-displacement curve of the seal 95 or 96. This property affects a series connection of several seals of different flexibility. In detail, seals with middle hump portions and stopper portions have a relatively small spread (sum of displacement distances) of a final compression over all seals. On the other hand, seals without stopper portions have a relatively significantly larger spread of a final seal compression over all seals.

In embodiments, referring again to portion (a) of FIG. 26 and portion (a) of FIG. 27, for extreme tightness requirements, the seal 95 or 96 can be supplemented with liquid sealant (not shown) in the cavities 954.

1. A humidifier stack for a humidifier device, the humidifier stack comprising:
frame plates following each other in a stacking direction in a plate stack comprising a dry gas channel and a moist gas channel;
a membrane separating the dry gas channel and the moist gas channel, the membrane enabling a moisture transfer from a fluid flow being guided in the moist gas channel to a fluid flow being guided in the dry gas channel; and
an at least partially circumferentially extending seal fixedly connected to the membrane, the at least partially circumferentially extending seal comprising flow channel seal sections disposed along circumferential edges of a moisture transfer surface of the membrane at a first surface of the membrane,
wherein other circumferential edges of the moisture transfer surface at the first surface are free of the flow channel seal sections,
the flow channel seal sections are in sealing contact with a neighboring one of the frame plates to form one of the dry gas channel and the moist gas channel in a region being delimited by the membrane, by the neighboring one of the frame plates, by another membrane, and the flow channel seal sections,
each of the flow channel seal sections engage around a respective one of the circumferential edges of the moisture transfer surface, and
each of the frame plates comprises at least one support element projecting away from a plate base plane, the at least one support element comprising, between an end of the support element facing away from the plate base plane and the plate base plane, at least one flow opening into one of the dry gas channel and the moist gas channel, and the at least one support element being supported at a second surface of the membrane that is facing away from the first surface of the membrane and that is free of the flow channel seal sections, in a region of the circumferential edges of the moisture transfer surface of the membrane, at which the flow channel seal sections are disposed, to introduce a seal pretensioning force into the flow channel seal sections.

2. The humidifier stack according to claim 1, wherein the plate stack is held together by tie rods, and
the membrane is exclusively fastened by clamping.

3. The humidifier stack according to claim 1, wherein the moisture transfer surface of the membrane has a rectangular shape,
the flow channel seal sections are disposed along two oppositely positioned circumferential edges of the moisture transfer surface at the first surface of the membrane, and
two other oppositely positioned circumferential edges of the moisture transfer surface at the first surface are free of the flow channel seal sections.

4. The humidifier stack according to claim 1, wherein the other circumferential edges of the moisture transfer surface of the membrane comprise inflow and outflow cross sections into one of the dry gas channel and the moist gas channel.

5. The humidifier stack according to claim 1, wherein each of the flow channel seal sections comprises one or more seal lips.

6. The humidifier stack according to claim 1, wherein a main flow direction in the moist gas channel extends at an angle to a main flow direction in the dry gas channel, and
the humidifier stack further comprises another at least partially circumferentially extending seal fixedly connected to the other membrane, the other at least partially circumferentially extending seal comprising other two flow channel seal sections disposed along two circumferential edges of another moisture transfer surface of the other membrane at another first surface of the other membrane, the two circumferential edges corresponding to the other circumferential edges of the moisture transfer surface of the membrane at the first surface of the membrane.

7. The humidifier stack according to claim 1, further comprising a membrane support element interposed between the membrane and the other membrane.

8. The humidifier stack according to claim 1, wherein each of the frame plates further comprises a support grid interposed between and connecting the at least one support element.

9. The humidifier stack according to claim 1, wherein the at least one support element comprises deep-drawn domed portions elevated out of the plate base plane and distributed along the circumferential edges of the moisture transfer surface of the membrane.

10. The humidifier stack according to claim 1, wherein the at least one support element comprises a pressure bar extending along and contacting areally a respective one of the circumferential edges of the moisture transfer surface of the membrane.

11. The humidifier stack according to claim 10, wherein the pressure bar is a folded-over section of a respective one of the frame plates, and
the at least one flow opening is disposed between spaced-apart bent sections of the respective one of the frame plates that connect the plate base plane to the pressure bar.

12. The humidifier stack according to claim 11, wherein the spaced-apart bent sections are configured to be elastically springy and to store a clamping force.

13. The humidifier stack according to claim 10, wherein the at least one support element further comprises one or more dimples disposed in the at least one support element and distributed along a length of the at least one support element, each of the one or more dimples being disposed into a top surface of the pressure bar, protruding from a bottom surface of the pressure bar and extending towards the plate base plane.

14. The humidifier stack according to claim 1, further comprising a secondary seal disposed at the second surface along the other circumferential edges at which, at the first surface, the flow channel seal sections are not disposed, the secondary seal being in contact with the at least one support element of the neighboring one of the frame plates.

15. The humidifier stack according to claim 14, wherein a thickness of the secondary seal is smaller than a thickness of the flow channel seal sections, and is flat.

16. The humidifier stack according to claim 1, wherein the plate stack further comprises supply and discharge channels extending in the stacking direction and connected in fluid communication to the dry gas channel and the moist gas channel, and
the supply and discharge channels comprise:
a first supply channel connected, as a dry gas supply channel, to an inlet side of the dry gas channel;
a second supply channel connected, as a moist gas supply channel, to an inlet side of the moist gas channel;
a first discharge channel connected, as a dry gas discharge channel, to an outlet side of the dry gas channel; and
a second discharge channel connected, as a moist gas discharge channel, to an outlet side of the moist gas channel.

17. The humidifier stack according to claim 16, wherein the supply and discharge channels are formed by corresponding flow pockets in the frame plates and the membrane that are stacked.

18. The humidifier stack according to claim 17, further comprising a flow pocket seal fixedly connected to a region externally surrounding the flow pockets of the membrane, the flow pocket seal sealing bi-directionally in relation to the frame plates,
wherein the flow pocket seal is injection-molded or glued to the membrane.

19. The humidifier stack according to claim 18, wherein each of the flow pocket seal and the at least partially circumferentially extending seal comprises:
a left stopper portion;
a right stopper portion;
a middle hump portion interposed between the left stopper portion and the right stopper portion, the middle hump portion having a height higher than that of the left stopper portion and the right stopper portion; and
at least one cavity interposed between the middle hump portion and each of the left stopper portion and the right stopper portion, through a top or bottom surface of a respective one of the flow pocket seal and the at least partially circumferentially extending seal.

20. The humidifier stack according to claim 1, further comprising at least one compression limitation element interposed between the frame plates, at least one compression limitation element presetting a minimum distance between frame plates and thereby delimiting a compression of the at least partially circumferentially extending seal in the stacking direction, and the compression limitation element being formed at a first one of the frame plates and being in contact with a second one of the frame plates.
